(19) United States
(12) Patent Application Publication
(10) Pub. No.: US 2017/0248927 A1
(43) Pub. Date: Aug. 31, 2017

(54) WEATHER ADAPTIVE CONTROL OF AN IRRIGATION SYSTEM

(71) Applicant: Energy Control technologies, Inc., Davie, FL (US)

(72) Inventor: Richard Combs, Plantation, FL (US)

(21) Appl. No.: 15/057,113

(22) Filed: Feb. 29, 2016

(51) Int. Cl. G05B 19/042; B05B 12/12; B05B 12/02; A01G 25/16

(52) U.S. Cl. CPC G05B 19/042; A01G 25/167; B05B 12/12; B05B 12/02; G05B 2219/2625

(57) ABSTRACT

Embodiments of the present invention provide for ground moisture content adaptive irrigation control. A method for ground moisture content adaptive irrigation control includes specifying a geographic region in memory of a computer and retrieving with respect to the geographic region from over a computer communications network, weather data that includes precipitation and temperature information. The method also includes computing by a processor of the computer moisture content of the ground within the geographic region utilizing the weather data. Finally, the method includes transmitting a command to an irrigation control system configured to control irrigation of the ground, the command modifying either a reduction in an irrigation schedule in the irrigation control system responsive to a determination that the ground is of a high moisture content, or an increase in the irrigation schedule responsive to a determination that the ground is of a low moisture content.

### BACKGROUND OF THE INVENTION

Field of the Invention

The present invention relates to control systems in general and more specifically control systems adapted for use in controlling irrigation and water delivery.

Description of the Related Art

Irrigation refers to the artificial application of water to land or soil. Irrigation typically is used to assist in the growing of agricultural crops, maintenance of landscapes, and for the re-vegetation of disturbed soils in dry areas and during periods of inadequate rainfall. Additionally, irrigation has been used effectively in crop production, including protecting plants against frost, suppressing weed growth in grain fields and preventing soil consolidation. Central to irrigation is a water distribution system that routes the flow of water from a central source of water such as a well or municipal conduit to different zones of irrigation in which one or more sprinkler heads spray or drip water onto the target zone.

In its most basic form, a water distribution system is managed through the manual actuation of different valves controlling the flow of water into one or more zones concurrently. However, in most instances, the control of the flow of water into different zones is controlled in an automated manner typically through the use of a microcontroller driven appliance that drives low voltage actuated valves responsive to rules stored in memory dictating a time and duration during which water is to flow from the water source to a particular zone or zones. Thus, primarily irrigation control systems manage only when and for how long a particular zone of irrigation receives water for delivery to the zone.

Notably, it is well recognized that excessive irrigation in a particular zone of irrigation can be damaging to the underlying vegetation. Likewise, under-watering of vegetation can lead to pest infestation, weed infestation and crop damage. Under-watering occurs during unexpectedly dry weather for a duration of time. Conversely, overwatering occurs during unexpectedly wet weather for a duration of time. In respect to the latter circumstance, many irrigation control systems receive input from a rain gauge that inhibits the delivery of water when rain has most recently occurred.

Yet, it is to be understood that the recent occurrence of rain while contributory, is hardly a definitive indication of the moisture content of the soil within a target zone of irrigation. In this regard, some soils drain more quickly than others. Further, a sporadic downpour amongst an extended duration of dry weather can be disastrous when a rain gauge prevents the operation of an irrigation system due to a singular, anomalous downpour in drought conditions. Therefore, a more robust manner of controlling irrigation is required so as to account more accurately for the moisture content of the soil of a target zone of irrigation.

### BRIEF SUMMARY OF THE INVENTION

Embodiments of the present invention address deficiencies of the art in respect to irrigation control and provide a novel and non-obvious method, system and computer program product for ground moisture content adaptive irrigation control. In an embodiment of the invention, a method for ground moisture content adaptive irrigation control includes specifying a geographic region in memory of a computer and retrieving with respect to the geographic region from over a computer communications network, weather data that includes precipitation and temperature information. The method also includes reading the existing evapotranspiration value within the geographic region utilizing the weather data. Finally, the method includes transmitting a command to an irrigation control system configured to control irrigation of the ground, the command modifying either a reduction in an irrigation schedule in the irrigation control system responsive to a determination that the ground is of a high moisture content, or an increase in the irrigation schedule responsive to a determination that the ground is of a low moisture content.

In this regard, an end user may configure the irrigation control system with an assigned estimated irrigation water flow rate. Alternatively, a flow rate sensor may be used in the irrigation control system to gauge an amount of water delivered at the direction of the irrigation control system. Utilizing the water flow rate, the irrigation control system may then calculate an optimum run time during which irrigation is performed in order to maintain the desired soil moisture content in addition to the needed irrigation frequency. The optimum run time may reflect either a reduction in an irrigation schedule in the irrigation control system responsive to a determination that the ground is of a high moisture content, or an increase in the irrigation schedule responsive to a determination that the ground is of a low moisture content.

In one aspect of the embodiment, the moisture content is computed in the processor of the computer at least in part based upon an evapotranspiration value provided by a weather data service, evaporation and groundwater recharge of the ground of the geographic region determined from the precipitation and temperature information for the geographic region. In another aspect of the embodiment, the geographic region is specified by a collection of geographic coordinates defining a geo-fence. In yet another aspect of the embodiment, a magnitude of the reduction is determined in accordance with a table correlating the weather data with a specified magnitude of reduction, and wherein a magnitude of the increase is determined in accordance with a table correlating the weather data with a specified magnitude of increase. Finally, in even yet another aspect of the embodiment, the precipitation information is representative of a sum of recent precipitation over a duration of days. In all cases, predictive data available provided by the weather data service may be utilized, such as real time approaching precipitation detection (with intensity) of a defined geographic area which may be used to inhibit an initiation of irrigation events probabilistic prediction (selected in %) of occurrence and precipitation duration.

In another embodiment of the invention, a ground moisture content adaptive irrigation control data processing system includes a multiplicity of irrigation control systems, each controlling delivery of water in a different geographic region. The system also includes a host computing system coupled to each of the control systems over a computer communications network. The host computing system includes at least one computer with memory and at least one processor. Finally, the system includes a ground moisture content adaptive irrigation control module. The module includes program code enabled upon execution in the host computing system to specify one of the geographic regions in a user interface to the module, to retrieve with respect to the specified one of the geographic regions from over the computer communications network, weather data comprising precipitation and temperature information, to compute moisture content of the ground within the specified one of the geographic regions utilizing the weather data, and to transmit a command to a corresponding one of the irrigation control systems for the specified one of the geographic regions, the command modifying either a reduction in an irrigation schedule in the corresponding one of the irrigation control systems responsive to a determination that ground in the specified of the geographic regions is of a high moisture content, or an increase in the irrigation schedule responsive to a determination that the ground is of a low moisture content.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for ground moisture content adaptive irrigation control;

FIG. 2 is a schematic illustration of a ground moisture content adaptive irrigation control data processing system; and,

FIG. 3 is a flow chart illustrating a process for ground moisture content adaptive irrigation control.

### DETAILED DESCRIPTION OF THE INVENTION

Embodiments of the invention provide for ground moisture content adaptive irrigation control. In accordance with an embodiment of the invention, a geographic region of interest is specified and weather data pertinent to the region of interest and indicative of ground moisture is retrieved from over a computer communications network. Thereafter, an irrigation scheduling rule is applied to the retrieved weather data in order to compute a modification to an existing irrigation schedule for ground within the region of interest. Finally, an irrigation system configured for irrigating the ground within the geographic region of interest is activated according to the modified irrigation schedule so as to appropriately deliver water to the ground within the geographic region of interest in consideration of an understood level of moisture within the ground.

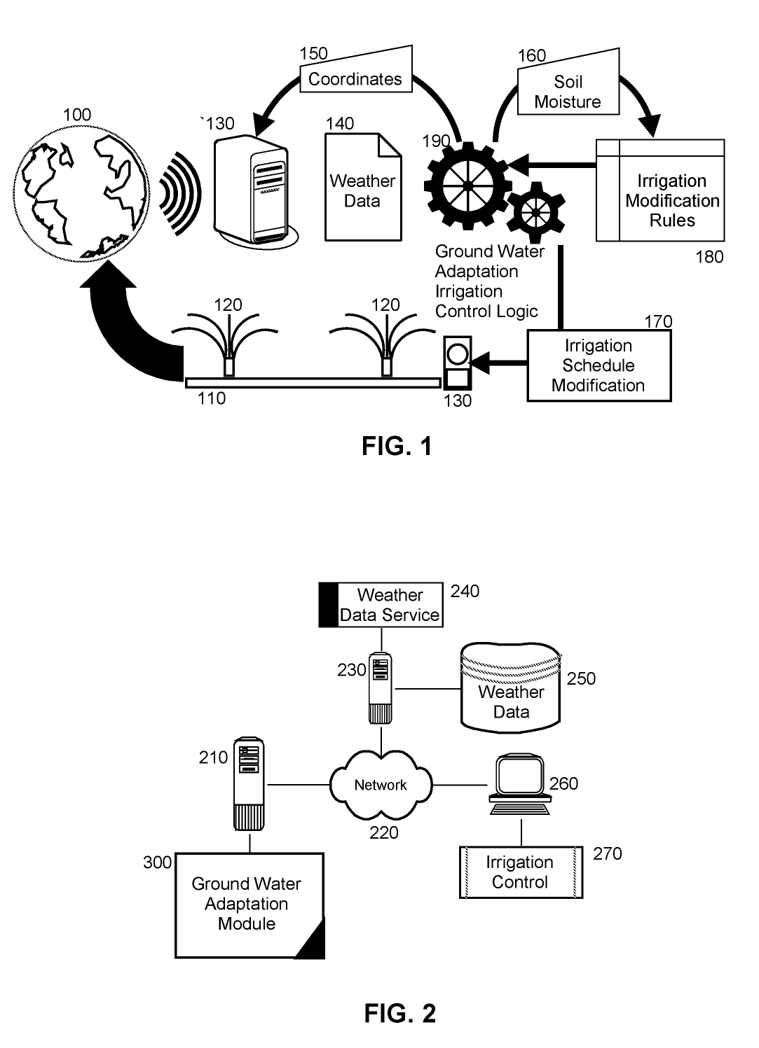

In further illustration, FIG. 1 is a pictorial illustration of a process for ground moisture content adaptive irrigation control. As shown in FIG. 1, an irrigation schedule is established and controlled within an irrigation control system 130 controlling irrigation 120 of ground with a geographic region 100. Ground water adaptation irrigation control logic 190 provides coordinates 150 of the geographic region 100 to a weather data service 130 which returns weather data 140 pertinent to the geographic region 100 to the ground water adaptation irrigation control logic 190. The ground water adaptation irrigation control logic 190 either retrieves or computes a ground moisture value 160 determined based upon the weather data 140 and applies the ground moisture value 160 to one or more rules defining one or more modifications to an irrigation schedule dependent upon a varying ground moisture value. The application of the ground moisture value 160 to the irrigation modification rules 180 produces a modification 170 to the irrigation schedule which is then submitted to the irrigation control system 130. In this way, a reduction or increase in irrigation is achieved adaptive to a computation of ground water in the ground 110.

The process described in connection with FIG. 1 is implemented in data processing system. In yet further illustration, FIG. 2 schematically shows a ground moisture content adaptive irrigation control data processing system. The system includes a host computing platform 210 including one or more computers, each with memory and at least one processor. The host computing platform 210 is communicatively coupled over computer communications network 220 to control device 260 comprising a processor or at least microcontroller including firmware 270 providing irrigation control. In this regard, the firmware 270 includes programmatic instructions executing by the processor to manage the timing and duration of irrigation flow to different zones of an irrigation system with respect to a particular geographic area.

The host computing platform 210 additionally is coupled to a remote host 230 over computer communications network 220 supporting the execution of a weather data service 240. The weather data service 240 is configured to receive an indication of a geographic region, for instance based upon geographic coordinates or a definition of an area based upon coordinates defining a geo-fence, and to respond to the receipt of the indication of the geographic region by retrieving from a database of weather data 250, weather data pertinent to the geographic region. The weather data includes information such as historical temperatures over a range of days, historical precipitation over a range of days as well as a real time approaching probability of rainfall in terms of a percentage value. Optional weather data includes wind speed over a range of days, air pressure over a range of days, and solar radiation over a range of days. As an additional option, the weather data includes an evapotranspiration value.

The host computing platform 210 supports the operation of a ground water adaptation module 300. The ground water adaptation module 300 includes program code that when executed by a processor within the memory of a computer of the host computing platform 210, is enabled to retrieving from over the computer communications network 220 from the weather data service 240, weather data for a specified geographic region. The program code additionally is enabled to compute ground moisture for the specified geographic region, for example by computing by the processor the Blaney-Criddle equation for evapotranspiration of the ground of the specified geographic region utilizing historic temperatures and daily percentage of annual daytime hours for a specified period of time, or by computing the Penman-Monteith equation for evapo-transpiration of the ground of the specified geographic region utilizing each of daily mean temperature, wind speed, relative humidity and solar radiation over a specified period of time for the specified geographic region. Alternatively, the program code is enabled to extract a pre-computed evapotranspiration value from the weather data.

Thereafter, the program code is enabled to apply one or more irrigation schedule modification rules to the computed evapo-transpiration value and also observed precipitation from the weather data in order to compute a modification to an irrigation schedule in order to account for the moisture of the ground of the specified geographic region. In this regard, the modification can be an increase in delivery of irrigation to the ground accounting for drier than expected conditions in the ground, or a decrease in delivery of irrigation to the ground accounting for wetter than expected conditions in the ground. Alternatively, the modification can include providing different irrigation start and stop times, on specific days of the week, based upon a known time zone for the specified geographic region. The program code is then enabled to transmit the modification to the irrigation schedule to the firmware 270 of the control device 260 so as to modify a scheduled delivery of irrigation to the ground within the specified geographic region.

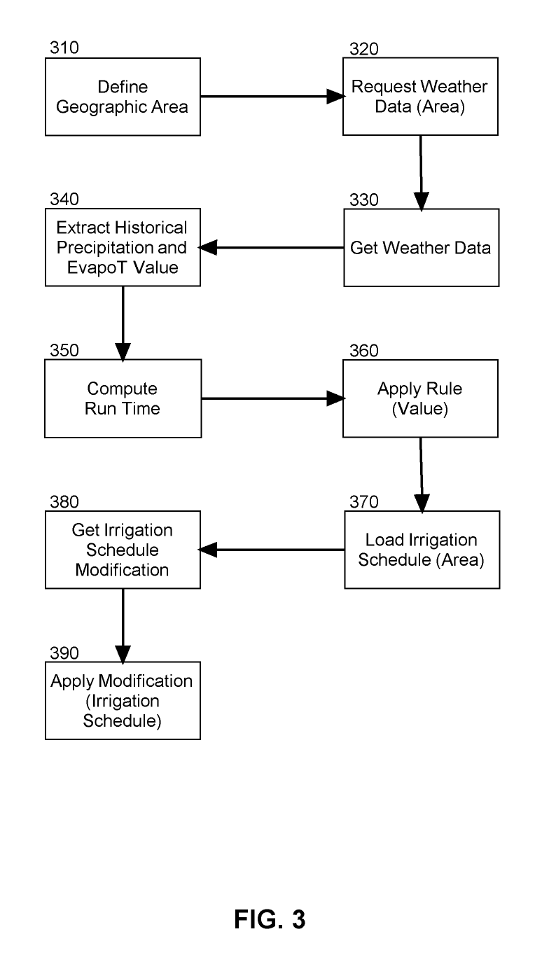

In even yet further illustration of the operation of the ground water adaptation module 300, FIG. 3 is a flow chart illustrating a process for ground moisture content adaptive irrigation control. Beginning in block 310, a geographic area is defined either in reference to geographic coordinates or in respect to a geo-fenced area, or by zip code, city name or the like. In block 320, a request for weather data is submitted over a network to a weather service for the specified geographic area. In block 330, weather data is retrieved from the weather service for the specified geographic region and in block 340, historical precipitation and temperature information and an evapo-transpiration value is extracted from the weather data.

Thereafter, in block 350 an irrigation run time is computed based upon the extracted information and the run time is applied to an irrigation schedule modification rule in block 360 to produce a modification to an irrigation schedule. In block 370, an irrigation schedule for the specified geographic area is loaded into memory and in block 380, the produced modification also is loaded into memory. Finally, in block 390 the modification is applied to the loaded schedule.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

I claim:

1. A method for ground moisture content adaptive irrigation control, the method comprising:
specifying a geographic region in memory of a computer;
retrieving with respect to the geographic region from over a computer communications network, weather data comprising precipitation and temperature information;
computing by a processor of the computer moisture content of the ground within the geographic region utilizing the weather data; and,
transmitting a command to an irrigation control system configured to control irrigation of the ground, the command modifying either a reduction in an irrigation schedule in the irrigation control system responsive to a determination that the ground is of a high moisture content, or an increase in the irrigation schedule responsive to a determination that the ground is of a low moisture content.

2. The method of claim 1, wherein the moisture content is computed in the processor of the computer at least in part based upon an evapotranspiration value computed by a combination of transpiration, evaporation and groundwater recharge of the ground of the geographic region determined from the precipitation and temperature information for the geographic region.

3. The method of claim 1, wherein the geographic region is specified by a collection of geographic coordinates defining a geo-fence.

4. The method of claim 1, wherein a magnitude of the reduction is determined in accordance with a table correlating the weather data with a specified magnitude of reduction, and wherein a magnitude of the increase is determined in accordance with a table correlating the weather data with a specified magnitude of increase.

5. The method of claim 1, wherein the precipitation information is representative of a sum of recent precipitation over a duration of days.

6. A ground moisture content adaptive irrigation control data processing system comprising:
a multiplicity of irrigation control systems, each controlling delivery of water in a different geographic region;
a host computing system coupled to each of the control systems over a computer communications network, the host computing system comprising at least one computer with memory and at least one processor;
ground moisture content adaptive irrigation control module comprising program code enabled upon execution in the host computing system to specify one of the geographic regions in a user interface to the module, to retrieve with respect to the specified one of the geographic regions from over the computer communications network, weather data comprising precipitation and temperature information, to compute moisture content of the ground within the specified one of the geographic regions utilizing the weather data, and to transmit a command to a corresponding one of the irrigation control systems for the specified one of the geographic regions, the command modifying either a reduction in an irrigation schedule in the corresponding one of the irrigation control systems responsive to a determination that ground in the specified of the geographic regions is of a high moisture content, or an increase in the irrigation schedule responsive to a determination that the ground is of a low moisture content.

7. The system of claim 6, wherein the moisture content is computed in the processor of the computer based at least in part upon an evapotranspiration value computed by a combination of transpiration, evaporation and groundwater recharge of the ground determined from the precipitation and temperature information for the specified one of the geographic regions.

8. The system of claim 6, wherein the geographic region is specified by a collection of geographic coordinates defining a geo-fence.

9. The system of claim 6, wherein a magnitude of the reduction is determined in accordance with a table correlating the weather data with a specified magnitude of reduction, and wherein a magnitude of the increase is determined in accordance with a table correlating the weather data with a specified magnitude of increase.

10. The system of claim 6, wherein the precipitation information is representative of a sum of recent precipitation over a duration of days.

11. A computer program product for ground moisture content adaptive irrigation control, the computer program product comprising a computer readable storage medium having program instructions embodied therewith, the program instructions executable by a device to cause the device to perform a method comprising:
specifying a geographic region in memory of a computer;
retrieving with respect to the geographic region from over a computer communications network, weather data comprising precipitation and temperature information;
computing by a processor of the computer moisture content of the ground within the geographic region utilizing the weather data; and,
transmitting a command to an irrigation control system configured to control irrigation of the ground, the command modifying either a reduction in an irrigation schedule in the irrigation control system responsive to a determination that the ground is of a high moisture content, or an increase in the irrigation schedule responsive to a determination that the ground is of a low moisture content.

12. The computer program product of claim 11, wherein the moisture content is computed in the processor of the computer at least in part based upon an evapotranspiration value computed by a combination of transpiration, evaporation and groundwater recharge of the ground of the geographic region determined from the precipitation and temperature information for the geographic region.

13. The computer program product of claim 11, wherein the geographic region is specified by a collection of geographic coordinates defining a geo-fence.

14. The computer program product of claim 11, wherein a magnitude of the reduction is determined in accordance with a table correlating the weather data with a specified magnitude of reduction, and wherein a magnitude of the increase is determined in accordance with a table correlating the weather data with a specified magnitude of increase.

15. The computer program product of claim 11, wherein the precipitation information is representative of a sum of recent precipitation over a duration of days.
